(19) United States
(12) Patent Application Publication
(10) Pub. No.: US 2014/0068088 A1
(43) Pub. Date: Mar. 6, 2014

(54) SYSTEMS AND METHODS FOR PROCESSING MEDIA ACCESS CONTROL (MAC) ADDRESSES

(71) Applicants: Venkata S. Krishnan, Ashland, MA (US); Anton Chernoff, Littleton, MA (US); Mark Hummel, Franklin, MA (US); David E. Mayhew, Northborough, MA (US)

(72) Inventors: Venkata S. Krishnan, Ashland, MA (US); Anton Chernoff, Littleton, MA (US); Mark Hummel, Franklin, MA (US); David E. Mayhew, Northborough, MA (US)

(73) Assignee: ADVANCED MICRO DEVICES, INC., Sunnyvale, CA (US)

(21) Appl. No.: 13/602,512

(22) Filed: Sep. 4, 2012

(51) Int. Cl. G06F 15/16

(52) U.S. Cl. 709/227

(57) ABSTRACT

Described are a system and method for processing a media access control (MAC) address. A communication is established between a processing device and a network port of a data switching device. The data switching device assigns a MAC address to the processing device. The assigned MAC address is directly associated with the network port of the data switching device absent a learning mechanism.

### FIELD OF THE INVENTION

The present invention relates generally to data networks, and more specifically, to systems and methods for processing MAC addresses.

### BACKGROUND

Large network environments such as data centers can provide Internet and intranet services supporting businesses and organizations. A typical data center can house various types of electronic equipment, such as computers, domain name system (DNS) servers, network switches, routers, data storage devices, and so on. A data center can have hundreds or thousands of interconnected server nodes communicating with each other and external devices via a switching architecture comprising switches, routers, etc. A server node is typically connected to a switch via a network interface, which requires a MAC address for communicating with other devices in the data center.

### BRIEF SUMMARY OF EMBODIMENTS

In accordance with an aspect, there is provided a computer-implemented method for processing a media access control (MAC) address, comprising: establishing a communication between a processing device and a network port of a data switching device; assigning, by the data switching device, a MAC address to the processing device; and directly associating the assigned MAC address with the network port of the data switching device absent a learning mechanism.

In accordance with another aspect, there is provided a computer-implemented method for message communications between first and second processing devices, comprising: establishing a communication between the first processing device and a first network port of a data switching device; establishing a communication between the second processing device and a second network port of the data switching device; assigning, by the data switching device, a first MAC address to the first processing device; assigning, by the data switching device, a second MAC address to the second processing device; directly associating the assigned first MAC address with the first network port of the data switching device absent a learning mechanism; and directly associating the assigned second MAC address with the second network port of the data switching device absent the learning mechanism.

In accordance with an aspect, there is provided an aggregation system, comprising a processing device; a data switching device having a network port in communication with the processing device; and an address processing engine that assigns a MAC address to the processing device and directly associates the assigned MAC address with the network port of the data switching device absent a learning mechanism.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a conventional computing environment;

FIG. 2 is a block diagram of a computing environment, in which embodiments of the present inventive concepts can be practiced;

FIG. 3 is a detailed block diagram of the address processing engine of FIG. 2, in accordance with an embodiment;

FIG. 4 is a flow diagram of a method for processing a MAC address, in accordance with an embodiment;

FIG. 5 is an illustration of data flow paths between a server node and an aggregation device, in accordance with an embodiment; and

FIG. 6 is an illustration of data flow paths between a source server node and a destination server node in communication with an aggregation device, in accordance with an embodiment.

### DETAILED DESCRIPTION

In the following description, specific details are set forth although it should be appreciated by one of ordinary skill that the systems and methods can be practiced without at least some of the details. In some instances, known features or processes are not described in detail so as not to obscure the present invention.

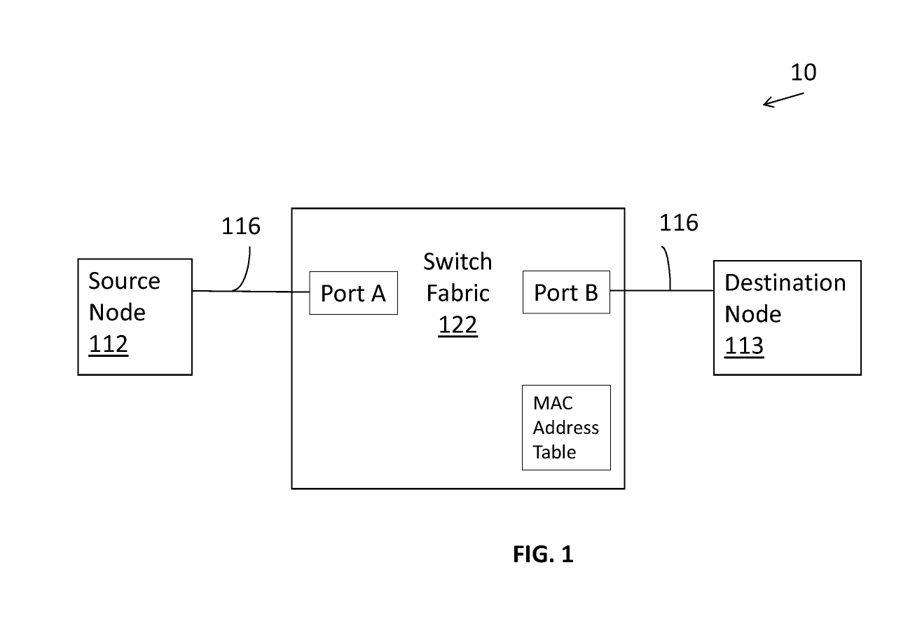

FIG. 1 is a diagram of a conventional computing environment 10. Server nodes 112, 113 are each coupled to a network switch fabric 122 by a physical connector 116, for example, an Ethernet connector. The server nodes 112, 113 can exchange data packets. In addition to a data payload, a data packet can include source MAC address and a destination MAC address. The switch 122 can maintain a MAC address table to forward packets from a source server node, for example, server node 112, to a destination server node, for example, server node 113. Upon receiving a packet at an ingress port, e.g., Port A, the switch 122 retrieves the source and destination MAC addresses of the packet, then queries its MAC address table for the forwarding port number according to the destination MAC address carried in the packet and, if it finds a match, then forwards the packet through an identified egress port, e.g., Port B. In a conventional network environment, if the MAC address does not exist in the MAC address table, a learning process is required, in which the switch 122 broadcasts the packet to all ports except the port at which the packet was received.

Here, MAC addresses can be exposed to spoofing. Thus, complex mechanisms may be implemented to validate incoming packets so as to prevent a malfunctioning or rogue network interface from injecting packets with spoofed source addresses, i.e., addresses that don't match the MAC address assigned to that interface.

Other traditional switches offer additional security features to detect packets with spoofed MAC addresses. Other approaches include the use of complex lookup tables in the switch to determine a target port for outputting a received packet to its destination. Explicit flow tags can be provided to reduce the complexity of the lookup. However, these solutions are complicated and require significant hardware at the switch for performing such operations.

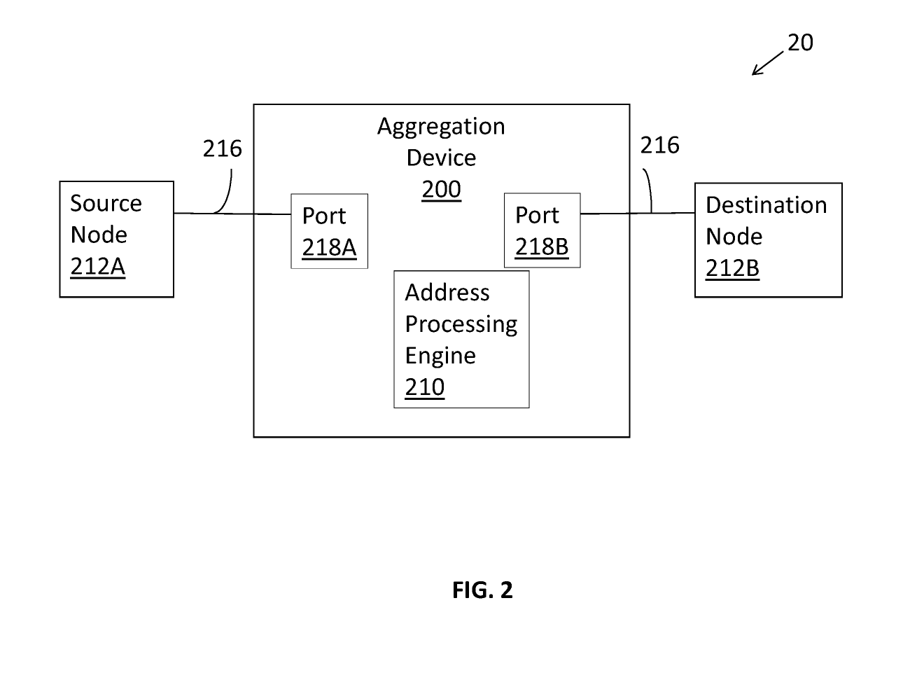

FIG. 2 is a block diagram of a computing environment 20 in which embodiments of the present inventive concepts can be practiced.

A source server node 212A and a destination server node 212B (generally, 212) are each coupled to an aggregation device 200 by a Peripheral Component Interconnect Express (PCIe) connector or the like for establishing a communication path 116 with an aggregation device 200. The combination of the aggregation device 200 and one or more server nodes 212 can be referred to as an aggregation system. Although two server nodes 212A, 212B are shown in FIG. 2, any number of processing nodes or other electronic devices can communicate with the aggregation device 200. One or more server nodes 212 can be virtualized.

The aggregation device 200 can be coupled between the server nodes 212 and one or more network interface cards (NICs) or related network adaptors, so that the server nodes 212 can communicate with remote electronic devices. The aggregation device 200 can be used as a connection fabric for the server nodes 212, which can be organized into a cluster, replacing some or all of the traditional Ethernet switching requirements used in conventional server racks. The server nodes 212 can comprise single socket servers or related microprocessor devices attached to the aggregation device 200 by PCIe interfaces and the like.

The aggregation device 200 includes an address processing engine 210 that assigns a MAC address to each server node 212, for example, during initialization of a server node 212 or a virtual machine of the server node 212. The address processing engine 210 also can map each assigned MAC address to a switch port connected to the server node 212 assigned the MAC address. For example, a MAC address assigned to the server node 212A can be mapped to a location of a switch port 218A, and a MAC address assigned to the server node 212B can be mapped to a location of a switch port 218B. The address processing engine 210 can map MAC addresses to switch ports in this manner to allow the aggregation device 200, more specifically, a switch fabric (not shown) of the aggregation device 200, to automatically validate a source MAC address during a data transfer operation from the source server node 212 to the destination server node 212B. Alternatively, the aggregation device 200 can embed or encode port information as part of the MAC address to simplify or eliminate a map table lookup. A data path to the destination server node 212B can be determined without the need for a MAC address table or for complex address learning mechanisms.

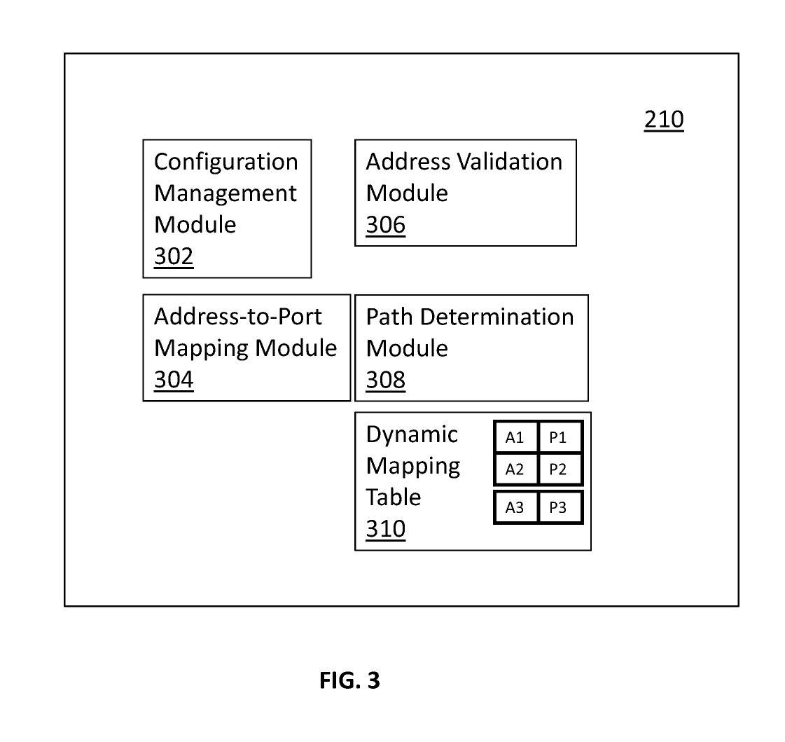

FIG. 3 is a detailed block diagram of the address processing engine 210 of FIG. 2, in accordance with an embodiment. The address processing engine 210 includes a configuration management module 302, an address-to-port mapping module 304, a packet validation module 306, a path determination module 308, and, optionally, a dynamic mapping table 310.

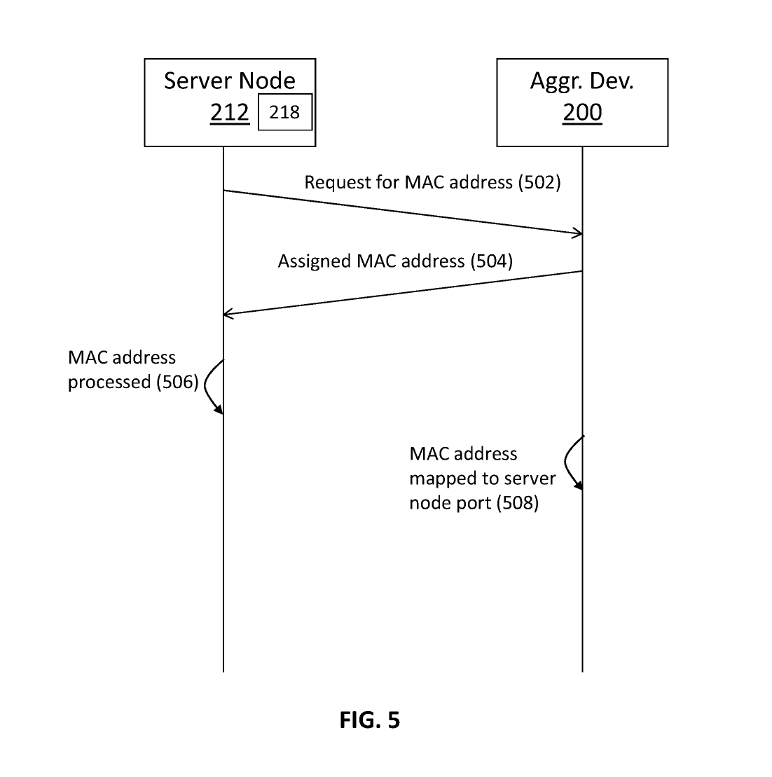

The configuration management module 302 generates MAC addresses that can be assigned to the server nodes 212. The MAC address can be generated and assigned to a node 212 in relation to an enumeration operation performed by the server node 212, described at FIG. 5. The server node 212 can be a non-virtualized processor-based device. Here, a MAC address can be generated for a network interface or other I/O-related hardware of the server node 212. Alternatively, the server node 212 can be a virtualized device, for example, including virtual machines, a hypervisor, and related virtual elements. Here, the configuration management module 302 can provide a network interface to a virtual machine running at the server node 212. When a new virtual machine is created, a hypervisor can communicate with the configuration management module 302. As part of the network interface provided by the configuration management module 302, a MAC address can be generated for each virtual machine. Thus, a server node 212 can include multiple network interfaces. For example, a server node 212 can include multiple NICs. In another example, a virtualized server node can include multiple vNICs.

The address-to-port mapping module 304 dynamically binds a MAC address generated for a server node 212 to a switch port to which the server node 212 is in communication. For example, referring to FIG. 2, a MAC address assigned to the server node 212A can be associated with a switch port 218A. A MAC address assigned to the server node 212B can be associated with a switch port 218B. The dynamic mapping table 310 can be constructed and arranged to map the MAC addresses to their corresponding switch ports. For example, a first entry in the table 210 can include a MAC address Al for the server node 212A, and a switch port number P1 corresponding to a switch port 218A to which the server node 212A is in communication. A second entry in the table 210 can include a MAC address A2 for the server node 212B, and a switch port number P2 corresponding to a switch port 218B to which the server node 212B is in communication. A table lookup can be obviated by embedding port information, e.g., a port number, in the address; one that can be extracted by hardware. In another embodiment, a combination of a table lookup and a processing of embedded port information can be performed.

The packet validation module 306 can automatically validate a source MAC address in a packet output from the source server node 212A. The packet validation module 306 compares the source MAC address in a packet received by the aggregation device 200 to the contents of the dynamic mapping table 310 to determine whether the received source MAC address matches the MAC address assigned to the port 218A at which the packet is received from the source server node 212A. Accordingly, MAC source address spoofing can be prevented. For example, if a rogue network interface injects a packet from the source server node 212A with a different MAC address, then the packet validation module 206 can detect the injected MAC address in response to performing a comparison between the rogue MAC address and the table entry that provides the port on which the packet is received and its corresponding actual MAC address.

The path determination module 308 can determine a path between the port 218A at which a packet is received and the destination server node 212B based on the MAC address-to-port data stored at the table 310. Accordingly, there is no need for the packet to be broadcast to the other switch ports of the aggregation device 200 as part of a learning process. The address processing engine 210 controls the distribution of MAC addresses and can therefore manage the relationships between the MAC addresses and corresponding switch ports, simplifying the path determination process between input and output ports.

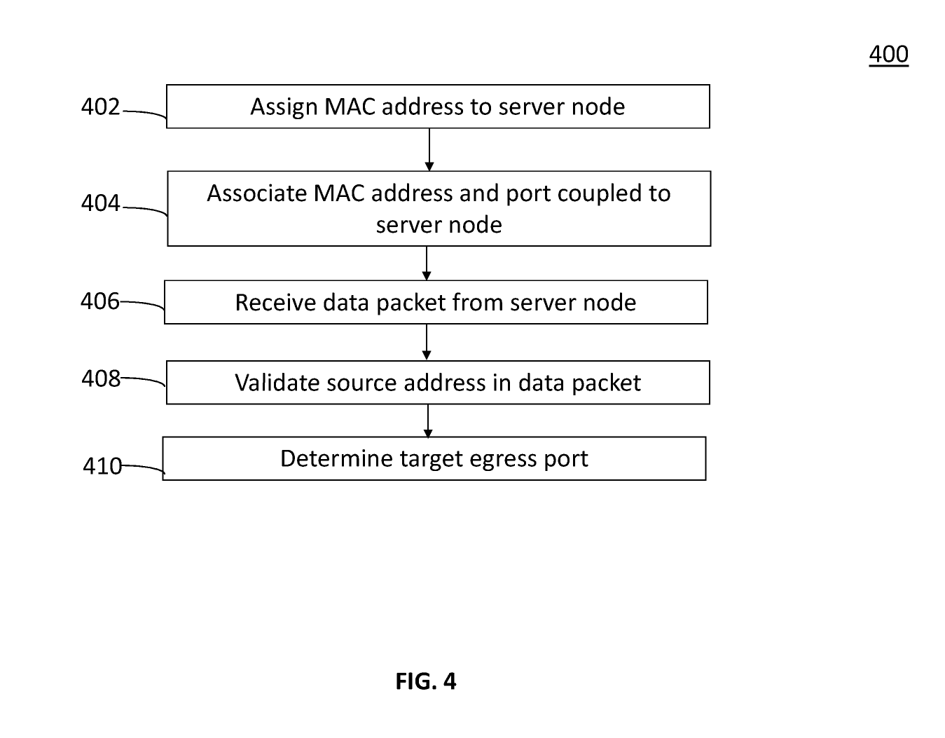

FIG. 4 is a flow diagram of a method 400 for processing a MAC address, in accordance with an embodiment. In describing the method 400, reference is made to elements of FIGS. 2 and 3. Some or all of the method 400 can be performed at the aggregation device 200, the source server node 212A, the destination server node 212B, or a combination thereof

At block 402, a MAC address is assigned to at least one of the source and destination server nodes 212A, 212B (generally, 212). The aggregation device 200 can assign MAC addresses where the aggregation device 200 provides a connection fabric for the server nodes 212, which can be coupled to the aggregation device 200 by PCIe connectors 216 and the like. In an embodiment, a server node 212 can be constructed and arranged to include a plurality of virtual machines. Here, each virtual machine can be assigned a MAC address by the aggregation device 200 according to a communication with a hypervisor, virtual switch, or related element of the server node 212.

At block 404, the assigned MAC address is associated with a server node port 218A at the address processing engine 210. For example, a MAC address assigned to the server node 212A can be mapped to the switch port 218A, and a MAC assigned to the server node 212B can be mapped to the switch port 218B. The MAC address of the destination server node 212B can be directly associated with its port at the time that the destination server node 212B establishes a communication with the aggregation device 200, for example, during initialization. In an embodiment, a server node 212 can be constructed and arranged to include a plurality of virtual machines. As described above, each virtual machine can be assigned a MAC address. Here, the MAC addresses of the virtual machines of the server node 212 can be mapped to a same port, e.g., port 218A.

At block 406, the address processing engine 210 receives a data packet from the source server node 212A. The data packet can include the MAC address of the source server node 212A, referred to as a source MAC address. The data packet can also include a MAC address of the destination device, for example, the MAC address of the server node 212B, referred to as a destination MAC address.

At block 408, the incoming data packet is validated. The source MAC address in the data packet can be compared to an entry at the dynamic mapping table 310 that identifies the ingress port 218A and the MAC address or addresses corresponding to the ingress port 218A. If there is a match between the MAC address received with the data packet and the mapping information, i.e., the MAC address-port 218A mapping, then the incoming data packet is validated.

At block 410, the target egress port is determined from the destination MAC address in the data packet. The destination MAC address in the data packet can be compared to an entry at the dynamic mapping table 310 that identifies the egress port 218B and the MAC address or addresses corresponding to the egress port 218B. If there is a match between the MAC address received with the data packet and the mapping information, i.e., the destination MAC address-egress port 218B mapping, then the incoming data packet is output to the destination server node 212B via the egress port 218B.

FIG. 5 is an illustration of data flow paths between a server node and an aggregation device, in accordance with an embodiment. In describing the data flow paths, reference is made to elements of FIGS. 2-4.

The server node 212 can perform an enumeration operation. For example, a server node BIOS can enumerate PCIe devices according to a PCIe bus enumeration operation. At flow path 502, the server node 212 can perform a query for a MAC address for one or more enumerated devices. For example, in embodiments where the server node 212 is virtualized, a query can be made for a MAC address for each virtual machine generated at the server node 212.

At flow path 504, the aggregation device 200 can provide one or more MAC addresses in response to the request made at flow path 502 with a MAC address. Here, the aggregation device 200 informs the server node 212 that it has a device available, for example, a NIC, in accordance with the request.

At flow path 506, the server node 212 processes the MAC address given to it by the aggregation device 200. The server node 212 can process the assigned MAC address by executing a driver for the device, e.g., NIC, corresponding to the assigned MAC address. At flow path 508, the MAC address or addresses assigned to the server node 212 can be mapped to a switch port 218 of the server node 212 in accordance with approaches described herein. Although flow path 506 is shown in FIG. 5 as occurring before flow path 508, a different sequence of flow paths can equally apply. For example, flow path 508 can occur before flow path 506.

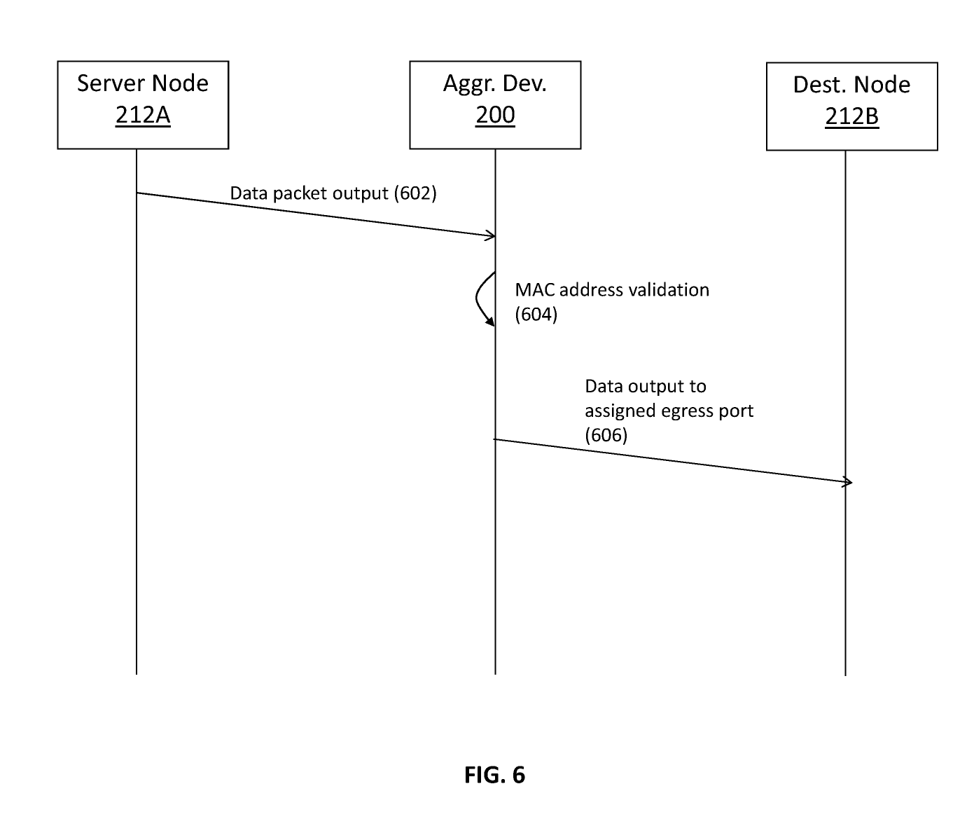

FIG. 6 is an illustration of data flow paths between a source server node 212A and a destination server node 212B in communication with an aggregation device, in accordance with an embodiment. In describing the data flow paths, reference is made to elements of FIGS. 2-4.

At flow path 602, a data packet is transmitted from a source server node 212A to an aggregation device 200. The data packet includes a source MAC address and a destination MAC address. The source and/or destination MAC addresses can be generated by the aggregation device 200 and provided to the source and destination server nodes 212A, 212B, respectively, for example, during an enumeration operation. The source and/or destination MAC addresses can correspond to physical and/or virtual devices at the server nodes 212.

At flow path 604, the aggregation device 200 validates that received source MAC address by comparing the received source MAC address in the data packet to the dynamic mapping table 310, which includes a set of MAC address/port pairings established according to methods described herein. One pairing includes the source MAC address and assigned ingress port. Another pairing includes the destination MAC address and assigned egress port.

At flow path 606, the data is output to the destination server node 212B via the egress port 218B. The data path to the destination server node 212B via the egress port 218B is determined from the dynamic mapping table 310.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific embodiments, it should be understood by those skilled in the art that various changes in form and detail may be made therein without departing from the spirit and scope of the invention.

What is claimed is:

1. A computer-implemented method for processing a media access control (MAC) address, comprising:
establishing a communication between a processing device and a network port of a data switching device;
assigning, by the data switching device, a MAC address to the processing device; and
directly associating the assigned MAC address with the network port of the data switching device absent a learning mechanism.

2. The computer-implemented method of claim 1, further comprising:
arranging the processing device to include a source node that transmits a data packet to a destination electronic device, the data packet including a source MAC address of the source node; and
automatically validating, at the data switching device, the source MAC address in the data packet.

3. The computer-implemented method of claim 2, wherein automatically validating the source MAC address in the data packet comprises:
comparing the source MAC address in the data packet to the assigned MAC address directly associated with the network port.

4. The computer-implemented method of claim 2, wherein the destination electronic device includes a processing device in communication with another network port of the data switching device.

5. The computer-implemented method of claim 4, further comprising:
assigning, by the data switching device, a destination MAC address to the destination electronic device; and
directly associated the destination MAC address with the other network port of the data switching device.

6. The computer-implemented method of claim 5, further comprising:
determining, from the destination MAC address, a data path to the destination electronic device; and
outputting data in the data packet from the data path to the destination electronic device via the other network port.

7. The computer-implemented method of claim 6, wherein determining the data path to the destination electronic device comprises:
comparing the destination MAC address in the data packet to the assigned destination MAC address directly associated with the other network port.

8. The computer-implemented method of claim 1, wherein directly associating the assigned MAC address with the network port includes mapping the assigned MAC address to the switch port.

9. The computer-implemented method of claim 1, wherein network port is mapped to a plurality of MAC addresses.

10. The computer-implemented method of claim 9, wherein each assigned MAC address of the plurality of MAC addresses corresponds to a virtual machine at the processing device.

11. The computer-implemented method of claim 1, wherein directly associating the assigned MAC address with the network port of the data switching device includes providing data related to the network port as part of the MAC address during the communication between a processing device and the data switching device.

12. A computer-implemented method for message communications between first and second processing devices, comprising:
establishing a communication between the first processing device and a first network port of a data switching device;
establishing a communication between the second processing device and a second network port of the data switching device;
assigning, by the data switching device, a first MAC address to the first processing device;
assigning, by the data switching device, a second MAC address to the second processing device;
directly associating the assigned first MAC address with the first network port of the data switching device absent a learning mechanism; and
directly associating the assigned second MAC address with the second network port of the data switching device absent the learning mechanism.

13. The computer-implemented method of claim 12, further comprising:
outputting a data packet from the first processing device to the second processing device, the packet including a source MAC address of the first processing device and a destination MAC address of the second processing device; and
automatically validating, at the data switching device, the source MAC address in the data packet.

14. The computer-implemented method of claim 13, wherein automatically validating the source MAC address in the data packet comprises:
comparing the source MAC address in the data packet to the assigned first MAC address directly associated with the network port;
determining that the source MAC address in the data packet matches the assigned MAC address associated with the first network port.

15. The computer-implemented method of claim 14, further comprising:
determining, from the second MAC address, a data path to the second processing device; and
outputting data in the data packet from the data path to the second processing device via the second network port.

16. An aggregation system, comprising:
a processing device;
a data switching device having a network port in communication with the processing device; and
an address processing engine that assigns a MAC address to the processing device and directly associates the assigned MAC address with the network port of the data switching device absent a learning mechanism.

17. The aggregation system of claim 16, further comprising a PCI connector that provides a communication path between the processing device and the data switching device.

18. The aggregation system of claim 16, wherein the address processing engine automatically validates a source MAC address in a data packet received from the processing device by comparing the source MAC address in the data packet to the assigned MAC address directly associated with the network port.

19. The aggregation system of claim 16, wherein the address processing engine assigns a destination MAC address to a destination processing device in communication with the data switching device and directly associates the destination MAC address with another network port of the data switching device.

20. The aggregation system of claim 19, wherein the address processing engine compares a destination MAC address in a data packet received by the processing device to the assigned destination MAC address to determine a data path to the destination processing device via the other network port.
